(19) United States
(12) Patent Application Publication
(10) Pub. No.: US 2024/0080571 A1
(43) Pub. Date: Mar. 7, 2024

(54) Managing Efficiency of Image Processing

(71) Applicant: Motional AD LLC, Boston, MA (US)

(72) Inventors: Ting Wang, Rancho Palos Verdes, CA (US); Eric Luo, South San Francisco, CA (US)

(21) Appl. No.: 18/139,902

(22) Filed: Apr. 26, 2023

Related U.S. Application Data
(60) Provisional application No. 63/363,621, filed on Apr. 26, 2022.

(51) Int. Cl. H04N 23/80

(52) U.S. Cl. CPC H04N 23/80; B60W 60/001

(57) ABSTRACT

Provided are methods for managing efficiency of image processing, which can include obtaining, using at least one SoC, raw data associated with a raw image from at least one camera; generating an updated image based on the raw image from the at least one camera, wherein the updated image represents photons received by the at least one camera; providing the updated image to an image and signal processing pipeline; processing the updated image using the image and signal processing pipeline; and operating a vehicle based at least in part on information obtained from an analysis of the processed image.

### CROSS-REFERENCE TO RELATED APPLICATIONS

The present application claims priority to U.S. Provisional Patent Appl. No. 63/363,621, filed Apr. 26, 2022, and incorporates herein by reference in their entireties the disclosure of the U.S. Non-Provisional patent application Ser. No. 18/139,526, titled “SCALABLE CONFIGURABLE CHIP ARCHITECTURE” filed on Apr. 26, 2023 and the U.S. Non-Provisional patent application Ser. No. 18/139,857, titled “DISTRIBUTED COMPUTING ARCHITECTURE WITH SHARED MEMORY FOR AUTONOMOUS ROBOTIC SYSTEMS” filed on Apr. 26, 2023.

### BACKGROUND

Autonomous vehicles incorporate computer processors and sensors in order to navigate on roads and other drivable areas. Information from sensors is preprocessed before use in navigation.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIGS. 4C and 4D are a diagram illustrating example operation of a CNN;

FIG. 5 is a diagram of an implementation of a process for managing efficiency of image processing; and

FIG. 6 is a flowchart of a process for managing efficiency of image processing.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

A vehicle (such as an autonomous vehicle) can process images from its cameras using a streamline image processing pipeline that omits steps not necessary for images used in, e.g., vehicle navigation. For example, an image captured by a camera is typically processing using an image and signal processing pipeline (ISP). Some of the processing steps produce images more suitable for the human eye but are not necessary for use of the image in vehicle navigation. Those steps can be omitted in the pipeline.

Some of the advantages of these techniques include faster image processing of camera data. By omitting unnecessary image processing steps, an image captured by the vehicle camera can be ready for use in navigation more quickly.

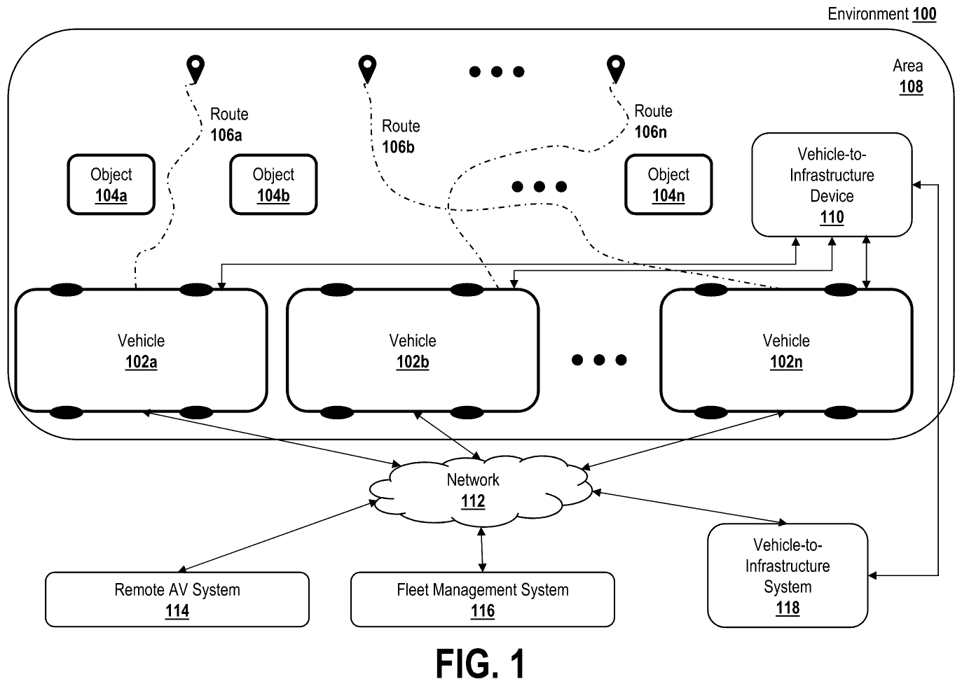

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

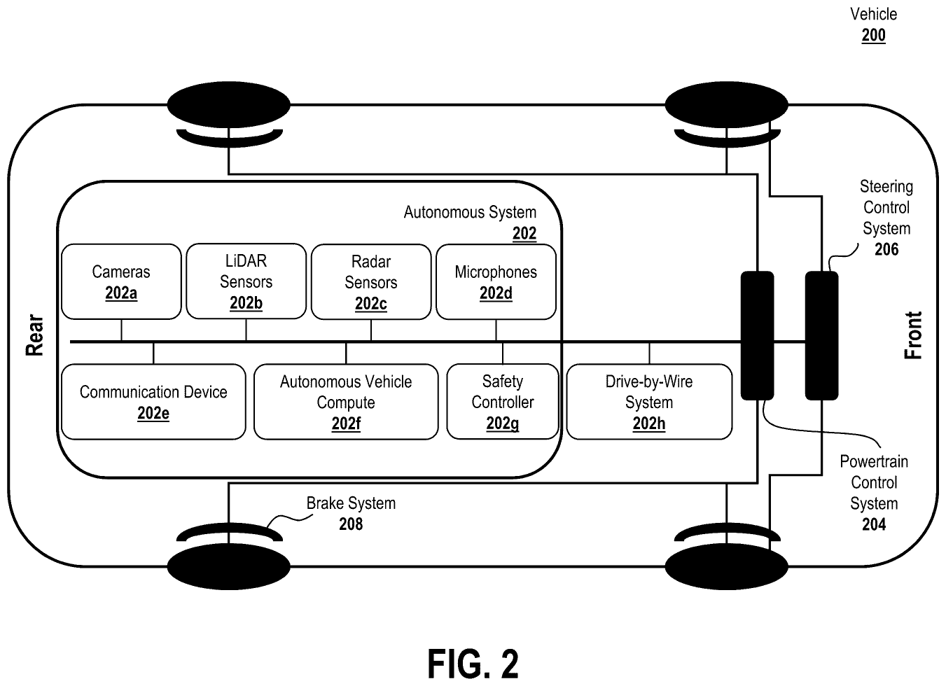

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicles 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operation or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

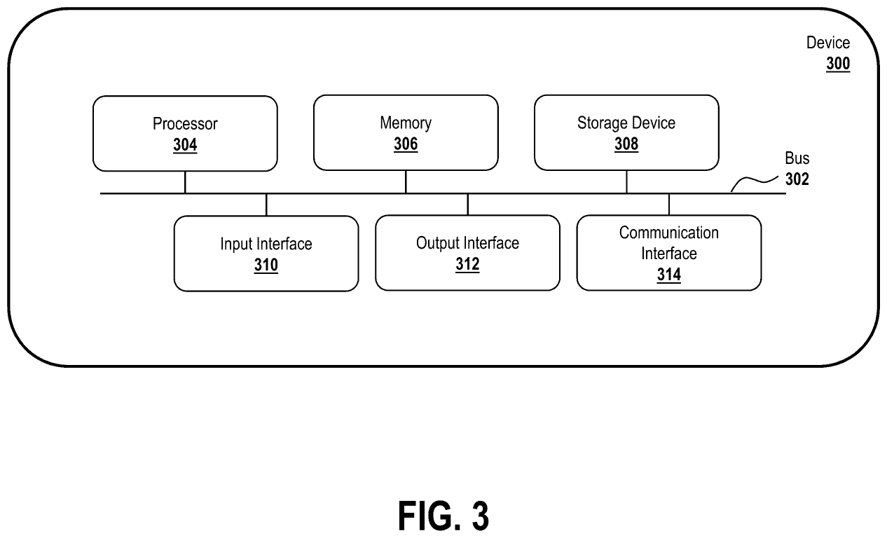

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charged-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is configured to implement autonomous vehicle software 400, described herein. In an embodiment, autonomous vehicle compute 202 f is the same or similar to distributed computing architecture. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102) and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

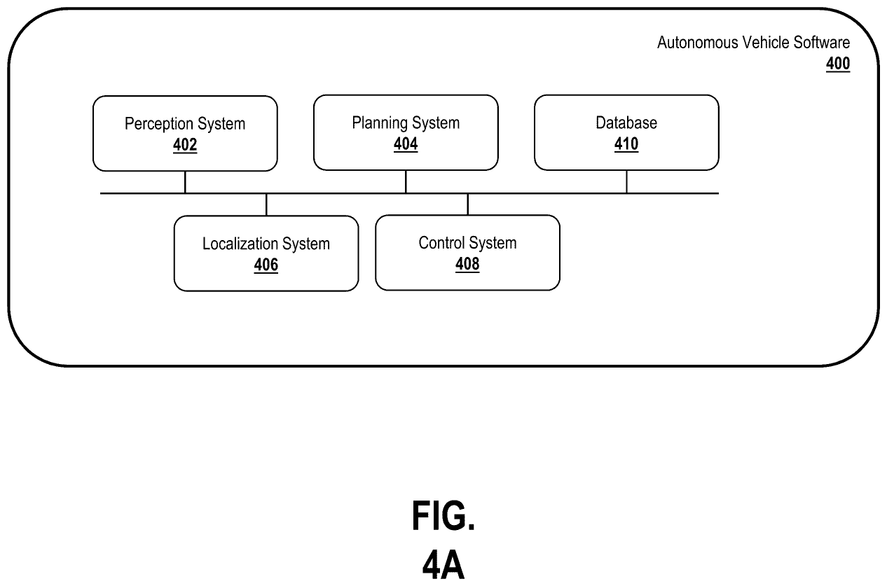

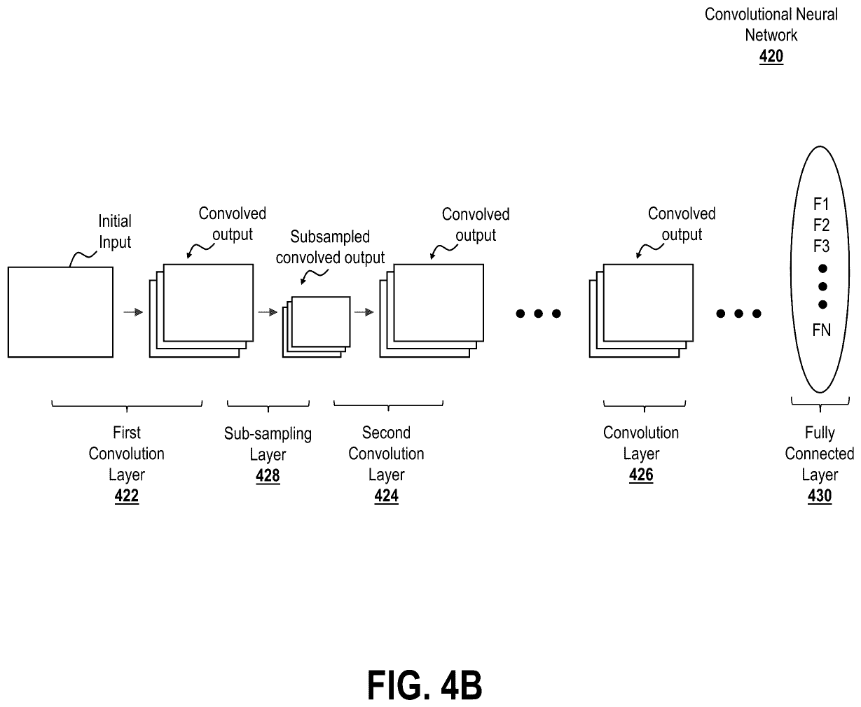

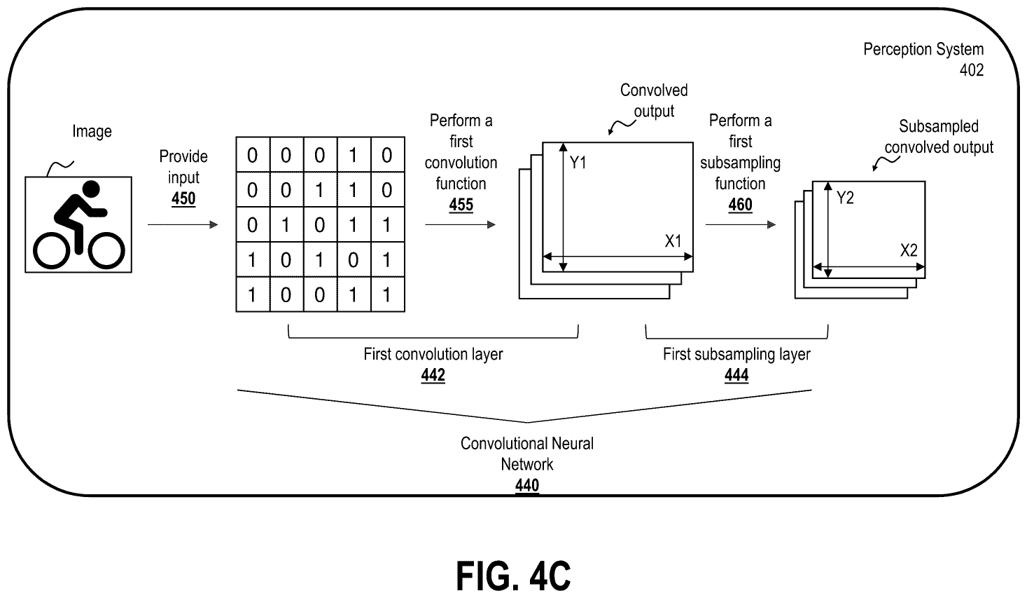

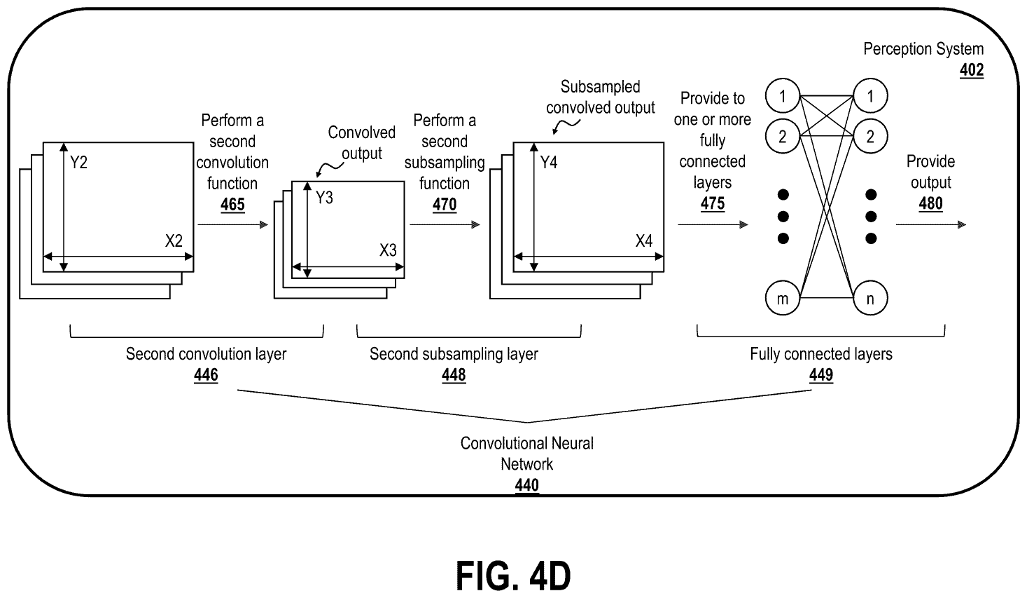

Referring now to FIG. 4, illustrated is an example block diagram of an autonomous vehicle software 400 (sometimes referred to as an “AV stack”). As illustrated, autonomous vehicle software 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle software 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle software 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle software 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle software 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 402 normalizing sensor data (e.g., image data, LiDAR data, radar data, and/or the like).

In some embodiments, CNN 420 generates an output based on perception system 402 performing convolution operations associated with each convolution layer. In some examples, CNN 420 generates an output based on perception system 402 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 430 includes data associated with a plurality of feature values referred to as F1, F2 . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

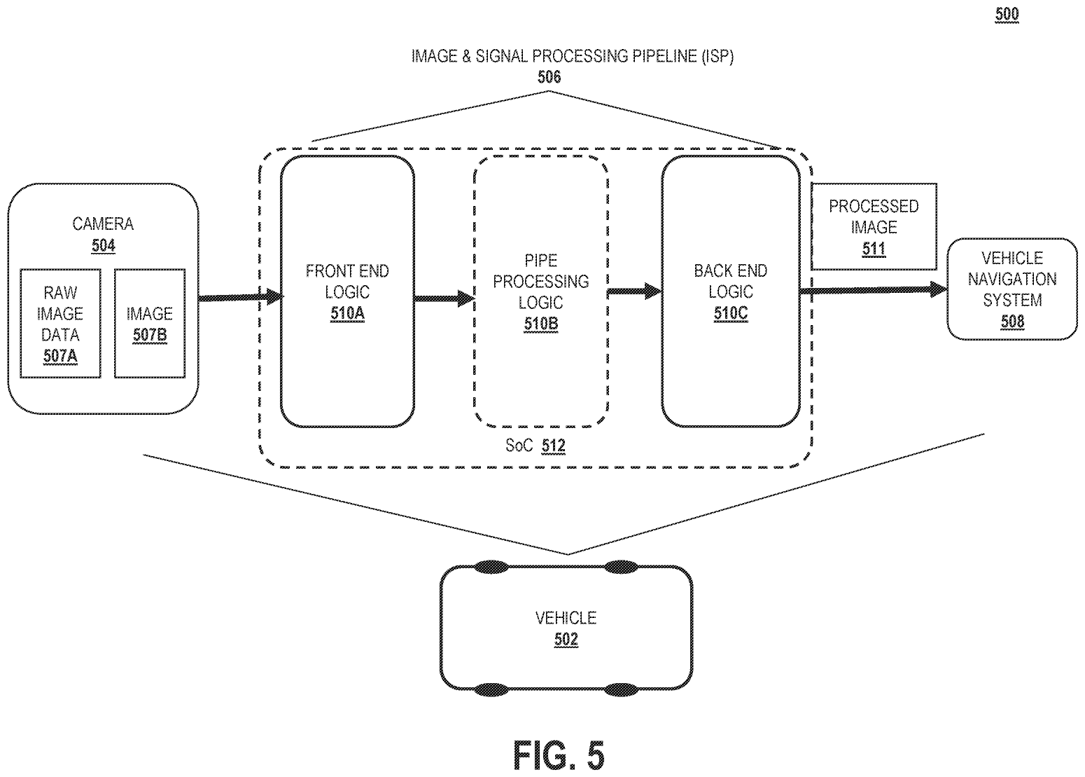

Referring now to FIG. 5, illustrated is a diagram of an example system 500 for managing efficiency of image processing, by which techniques of the present disclosure can be implemented. As shown in FIG. 5, the example system 500 includes a vehicle 502, a camera 504, an image and signal processing pipeline (ISP) 506, and a vehicle navigation system 508. The example system 500 can also incorporate other components associated with operation of the vehicle 502 (as described with reference to FIGS. 1-4). The vehicle 502 includes an autonomous vehicle, such as vehicle 200 described with reference to FIG. 2. The vehicle 502 can be configured to include or to be coupled to any of the camera 504, the ISP 506, and the vehicle navigation system 508. The vehicle 502 can be configured to execute one or more operations based on images captured by the camera 504 and processed by the ISP 506.

The camera 504 can include one or more sensing devices (e.g., one of the cameras 202a shown in FIG. 2) communicatively coupled with the vehicle 502, the ISP 506, and the vehicle navigation system 508. For example, the camera 504 can include a sensor configured to generate a raw image 507A and an electronics module configured to generate an image 507B. The image sensor contained within the sensor module can include any of a variety of video sensing devices, including, for example, a charged-coupled device (CCD), a complementary metal-oxide semiconductor (CMOS), vertically stacked CMOS devices, or a multi-sensor array using a prism to divide light between the sensors. In some embodiments, the image sensor can include a CMOS device having multiple (e.g., millions of) photocells.

In some embodiments, the camera 504 can generate the raw image data 507A by controlling an acquisition time of the sensor module and by approximating an amount of photons, instead of waiting for photons to cause a capture element (e.g., CCD) to release the energy. In some configurations, the camera 504 can be configured to output images 507B as a video (e.g., a set of frames acquired at multiple time points during a time interval) with a set resolution and a set frame rate (e.g., that can vary based on a state of the vehicle 502, being lower for a stationary state and higher for a moving state). Additionally, the image sensor of the camera 504 can be configured to provide variable resolution by selectively outputting only a predetermined portion of the sensor (e.g., that can vary based on a state of the vehicle 502, such as being narrower for a stationary state and wider for a moving state). The camera 504 can also be configured to downsample and subsequently process the output of the sensor to yield video output at a set resolution. For example, the raw image data 507A from the sensor can be “windowed” (reduced to a set size), thereby reducing the size of the output image 507B and allowing for higher readout speeds. As another example, the sensor modules of the camera 504 having different sensor sizes may be exchanged depending upon settings associated with a state of the vehicle 502. The camera 504 can be configured to apply a filter (e.g., Bayer pattern filter) to up-sample the raw image data 507A output by the sensor to yield the image 507B output at modified (e.g., higher or lower) resolutions. In some embodiments, the sensor, by way of its chipset (not shown), outputs the raw image data 507A representing magnitudes of red, green, or blue light detected by individual photocells of the image sensor. Any of a variety of sensor sizes or other sensor characteristics may be utilized in the modular camera 504 of the example system 500. The electronics contained in the sensor and electronics module can be digital signal processing electronics for processing the raw image data 507A captured by the sensor.

The sensor module may be configured to deliver any of a variety of desired performance characteristics. The camera 504 can include a separate compression module, or the compression electronics can be included within the sensor module. The compression electronics can be in the form of a separate chip or it can be implemented with software and another processor. For example, the compression electronics can be in the form of a commercially available compression chip that performs a compression technique to generate the image 507B in accordance with the settings of the ISP 506. The camera 504 can include a sensor module configured to perform any type of compression process on the raw image data 507A from the sensor. In some embodiments, the sensor module performs a compression technique configured to reduce the size of the image 507B. The image 507B can be derived from the raw image data 507A. For example, the image 507B can represent photons received by the camera 504. The camera 504 can transmit the image 507B and, optionally, the raw image data 507A to the ISP 506 for additional processing.

The ISP 506 can include one or more devices communicatively coupled with the vehicle 502, the camera 504, and the vehicle navigation system 508. For example, the ISP 506 can include a combination of software and hardware structured as a front end processing logic 510A, a pipe processing logic 5106, and a back end processing logic 510C. The front-end processing logic 510A, the pipe processing logic 5106, and the back end processing logic 510C can each be configured to process the received images. In some embodiments, each of the front-end processing logic 510A, the pipe processing logic 5106, and the back end processing logic 510C can apply different filters to the images 507A, 507B for example for adjusting color balance, applying a HDR (high definition range) filter, applying a de-noising filter, applying a gamma correction filter, and/or applying a brightness filter. The image 507B and, optionally, the raw image data 507A received from the camera 504, may first be processed by the ISP front-end processing logic 510A and analyzed to capture image statistics that may be used to determine one or more control parameters for the ISP pipe logic 5106 and/or the camera 504.

The ISP front-end processing logic 510A may be configured to process the image 507B and, optionally, the raw image data 507A. The ISP front-end processing logic 510A may operate within its own clock domain and may provide an asynchronous interface to the sensor interface to support images 507A, 507B of different sizes and timing requirements that can vary based on different states of the vehicle 502. In some embodiments, the front-end processing logic 510A can process the raw image data 507A received from the camera 504 and may use the processing results of the raw image data to update a setting of the camera 504. The ISP front-end processing logic 510A can process the images 507A, 507B on a pixel-by-pixel basis in a number of formats. For instance, each image pixel may have a bit-depth of 8, 10, 12, or 14 bits. The ISP front-end processing logic 510A may perform one or more image processing operations on the raw image data 507A, as well as collect statistics about the image data 507B. The image processing operations, as well as the collection of statistical data, may be performed at the same or at different bit-depth precisions. For example, in one embodiment, processing of the images 507A, 507B may be performed at a precision of 14-bits. Within the given example, raw pixel data received by the ISP front-end processing logic 510A that has a bit-depth of less than 14 bits (e.g., 8-bit, 10-bit, 12-bit) may be up-sampled to 14-bits for image processing purposes. In some embodiments, front-end processing logic 510A may perform statistical processing at 8-bits and, the images 507A, 507B having a higher bit-depth may be down-sampled to an 8-bit format for statistics purposes. The down-sampling to 8-bits may reduce hardware size (e.g., area) and also reduce processing/computational complexity for the statistics data. In some embodiments, front-end processing logic 510A may perform spatial averaging using the images 507A, 507B to allow data de-noising. In some embodiments, front-end processing logic 510A may perform temporal filtering and/or binning compensation filtering on the images 507A, 507B. The front-end processing logic 510A may send the processed image data to the ISP pipe logic 510B for additional processing prior to being se the vehicle navigation system 508.

The ISP pipe logic 510B can receive the “front-end” processed data, e.g., directly from the ISP front-end processing logic 510A, and may provide for additional processing of the image data, for example, in the raw domain, as well as in the RGB and YCbCr color spaces. Image data processed by the ISP pipe logic 510B may then be sent to the back end processing logic 510C to generate processed images 512. The back end processing logic 510C can include a transmission formatting engine, such as a compression engine for encoding the processed images 512 to optimize data transmission to the vehicle navigation system 508.

The vehicle navigation system 508 can include one or more devices communicatively coupled with the vehicle 502, the camera 504, and the ISP 506. For example, the vehicle navigation system 508 can receive the processed images 512, as input from the ISP 506 to provide one or more instructions for operating the vehicle 502. For example, the vehicle navigation system 508 can include a perception system (e.g., perception system 402 described with reference to FIG. 4A), a planning system (e.g., planning system 404 described with reference to FIG. 4A), a localization system (e.g., localization system 406 described with reference to FIG. 4A), a control system (e.g., control system 408 described with reference to FIG. 4A). The vehicle navigation system 508 can receive the processed images 512 including data associated with at least one physical object (e.g., data that is used by the vehicle navigation system 508 to detect the at least one physical object) in an environment and classifies the at least one physical object. In some examples, the vehicle navigation system 508 receives the processed images 512 associated with (e.g., representing) one or more physical objects within a field of view of the camera 504. In such an example, the vehicle navigation system 508 classifies at least one physical object based on one or more groupings of physical objects (e.g., bicycles, vehicles, traffic signs, pedestrians, and/or the like) and can determine a maneuver of the vehicle 502. In some embodiments, the vehicle navigation system 508 transmits data associated with the one or more instructions for operating the vehicle 502 to another component of the vehicle 502 to execute the operations of the vehicle 502 including navigation of the vehicle.

In some embodiments, one or more components of the example system 500, such as the ISP 506 and, optionally, (a portion of) the vehicle navigation system 508, are included in an integrated circuit, such as a “system on a chip” (SoC) 512 with functionality specific to implementing the ISP 506. The SoC 512 refers to an integrated circuit (or a “chip”) that integrates all or most components of a computing system and/or other electronic systems. Such components include, for example, a central processing unit (CPU), input/output (I/O) devices, memory, storage, etc. Other components may include various communication components, graphics processing units (GPU), etc. These components may be integrated on a single substrate or microchip. Various digital, analog, mixed-signal, and/or radio frequency (RF) signal processing functions, etc. may be incorporated as well. The SoC can integrate a microcontroller, a microprocessor and/or one or more processor cores with a GPU, Wi-Fi and/or cellular network radio components, etc. Similar to how a microcontroller integrates a microprocessor with peripheral circuits and memory, the SoC 512 can be seen as integrating a microcontroller with even more advanced peripherals. In some embodiments, the ISP 506 includes one or more SoCs 512. In some examples, one or more of the steps 510a-c corresponds to one or more SoCs 512. For example, each of the front-end processing logic 510A, the pipe processing logic 5106, and the back end processing logic 510C can be included in a SoC 512 that provides input to another SoC 512 representing another component of the ISP 506.

With continued reference to FIG. 5, one or more functions will be described as being performed by the example system 500. The number and arrangement of the components and/or devices of the example system 500, shown in FIG. 5 are provided as an example. There may be additional systems and/or devices, fewer systems and/or devices, different systems and/or device, or differently arrangement systems and/or devices than those shown in FIG. 5. Furthermore, two or more systems and/or devices show in FIG. 5 may be implemented within a single system or a single device, or a single system or a single device shown in FIG. 5 may be implemented as multiple, distributed systems or devices. Additionally, or alternatively, a set of systems or a set of devices (e.g., one or more systems, one or more devices) of the example system 500 may perform one or more functions corresponding to different types of scenarios, described as being performed by another set of systems or another set of devices of the example system 500. The examples of scenario types include “high-traffic scenario,” “crowded pedestrian scenario,” “highway scenario”, “local road scenario”, “parking lot scenario” or other scenarios that can be encountered by the vehicle 502.

In some embodiments, the camera 504 generates raw image data 507A including an approximated amount of photons. The ISP 506 can be used to enhance the image 507B generated from the raw image data 507A, in which an amount of photons captured is approximated. For example the amount of photons captured can be approximated (using a parabolic approximation of a photon transfer curve based on an initial set of detected amount of photons) to save time and to save the resources of the example system 500. The raw image data 507A captured using the photon amount approximation techniques can be processed by the ISP to generate a processed image 512 with a format usable by the vehicle navigation system 508 controlling the operations of the vehicle 502.

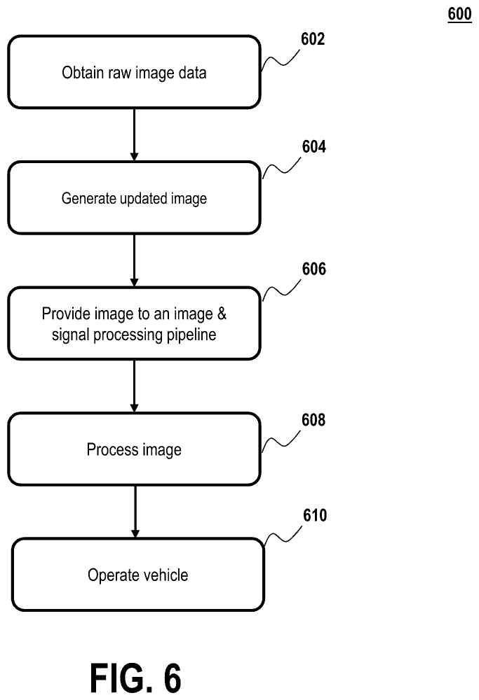

In some embodiments, the image processing performed by the ISP 506 can be adapted based on planned uses of the image 507B. For example, the ISP 506 can perform additional image processing steps if the processed image 512 is planned to be displayed on a user interface for human visualization (e.g., to make components or colors of the image more visibly clear to the human eye). As another example, some image processing steps can excluded when the processed image 512 is not intended to be viewed by the human eye, being used by the vehicle's automatic navigation processes (e.g., perception and planning) that do not involve human vision. Accordingly, one or more steps are omitted when the ISP 506 is applied to the image 507B in certain circumstances. For example, if the processed image 512 is planned to be used for a purpose not requiring a particular processing step, the respective processing step can be omitted, and the image undergoing processing can be provided by the previous processing step to a subsequent processing step. By omitting one or more image processing steps, a processed image 512 can be generated by the ISP 506 in a shorter amount of time than if all processing steps were executed. Further details about the processes performed by the example system 500 are described with reference to FIG. 6.

Referring now to FIG. 6, illustrated is a flowchart of an example process 600 for managing efficiency of image processing. In some embodiments, one or more of the steps described with respect to process 600 are performed (e.g., completely, partially, and/or the like) by the vehicle 502 and ISP 506 shown in FIG. 5. Additionally, or alternatively, in some embodiments one or more steps described with respect to process 600 are performed (e.g., completely, partially, and/or the like) by another device or group of devices separate from or including the vehicle 502 and ISP 506. In some embodiments, steps of the process 600 are carried out by one or more hardware components, e.g., SoCs. SoCs are described in more detail above with respect to FIG. 5. For example, one or more of the operations described with respect to the example process 600 is performed (e.g., completely, partially, sequentially, non-sequentially, and/or the like) by the perception system 402, the planning system 404, and/or the control system 408 of the autonomous vehicle compute 400 of a vehicle (e.g., vehicle 102a, 102b, 102n described with reference to FIG. 1 or vehicle 200 described with reference to FIG. 2, or vehicle 502 described with reference to FIG. 5). Additionally, or alternatively, in some embodiments, one or more steps described with respect to the example process 600 is performed (e.g., completely, partially, sequentially, non-sequentially, and/or the like) by another device or group of devices separate from or including the autonomous vehicle compute 400 and/or the example system 500.

At 602, raw image data is obtained from a camera (e.g., camera 202a described with reference to FIG. 2 and/or the camera 504 shown in FIG. 5) that can be attached to or coupled to a vehicle. For example, the camera can generate images of an environment surrounding the vehicle, the environment including agents that can interfere with a pathway and/or maneuver of the vehicle, to which they are attached. The raw image data can be generated using photon amount approximation techniques. In some embodiments, the raw image data is obtained by the camera according to a (stationary or mobile) status of the vehicle. For example, a “crowded pedestrian scenario” may necessitate the use of a larger amount of image frames per second (with a higher resolution) in order to accurately perceive a large number of pedestrians and safely navigate around those pedestrians. In such a scenario, the vehicle may operate the camera in a way that gathers the most amount of data per unit time. Examples of such camera operation include operating a camera at a high rotational frequency. In contrast, some scenarios do not necessitate the use of as many computational resources. As another example, a “parking lot scenario” can use fewer computational resources than the “crowded pedestrian scenario” described above. In the “parking lot scenario”, the camera can be set to a lower frame rate (e.g., 30 FPS instead of 60 FPS), and a lower rotational frequency (e.g., 20 Hz instead of 60 Hz) at which the vehicle can safely navigate while using less power and can extend the battery life of the vehicle's systems. Because less data is being gathered and processed, less bandwidth is used by the vehicle's communications networks (e.g., the bus 302 shown in FIG. 3).

At 604, an updated image is generated (e.g., by an electronics module of the camera) based on processing the raw image from the camera. The processing of the raw image can include noise removal techniques to minimize possible spatial variations and, optionally, a compression technique configured to reduce the size of the image. The noise removal techniques can be based on the camera configuration (e.g., sensor noise performance) and image acquisition settings. The updated image can include a representation of photons received by the camera corresponding to signal levels as a function of distance from imaged agents within the environment.

At 606, the image with processing information are provided to an image and signal processing (ISP) pipeline (e.g., the ISP 506 shown in FIG. 5). The processing information can be provided as metadata, generated by a different component of the vehicle. The processing information can indicate a planned usage of the image that is associated to one or more processing operations of the ISP pipeline. For example, the planned usage can indicate whether the image is scheduled to be displayed by a user interface (e.g., communication device 202e described with reference to FIG. 2) to be viewed by a human eye. The planned usage of the image indicating that the image is planned to be excluded from a display of the user interface, at least a portion of the processing to be performed by the ISP can be omitted from the image processing. For example, if the image is not scheduled be viewed by the human eye, a color balancing step can be omitted.

At 608, the image can be processed, by the ISP pipeline, according to the determined processing plan. In some embodiments, different portions of the image processing are performed by different components of the ISP pipeline, even if the ISP pipeline omits steps identified for omission. The image processing can include application of multiple filters to obtain information about the environment surrounding the vehicle.

At 610, the vehicle is operated based at least in part on information obtained from an analysis of the processed image. For example, the processed image is provided to a vehicle navigation system (e.g., the perception system 402 described with reference to FIG. 4) for use in identifying objects proximate to the vehicle to enable a safe maneuver of the vehicle to safely navigate around the identified agents to avoid collisions.

According to some non-limiting embodiments or examples, provided is a vehicle, comprising: at least one computer-readable medium storing computer-executable instructions; at least one processor communicatively coupled to at least one camera and configured to execute the computer executable instructions, the execution carrying out operations including: obtaining, using at least one SoC, raw data associated with a raw image from at least one camera; generating, using the at least one SoC, an updated image based on the raw image from the at least one camera, wherein the updated image represents photons received by the at least one camera; providing, using the at least one SoC, the updated image to an image and signal processing pipeline; processing, using the at least one SoC, the updated image using the image and signal processing pipeline; and transmitting instructions for causing the vehicle to operate based at least in part on information obtained from an analysis of the processed image.

According to some non-limiting embodiments or examples, provided is at least one non-transitory computer-readable medium comprising one or more instructions that, when executed by at least one processor, cause the at least one processor to perform operations comprising obtaining, using at least one SoC, raw data associated with a raw image from at least one camera; generating, using the at least one SoC, an updated image based on the raw image from the at least one camera, wherein the updated image represents photons received by the at least one camera; providing, using the at least one SoC, the updated image to an image and signal processing pipeline; processing, using the at least one SoC, the updated image using the image and signal processing pipeline; and transmitting instructions for causing the vehicle to operate based at least in part on information obtained from an analysis of the processed image.

According to some non-limiting embodiments or examples, provided is a method, comprising: obtaining, using at least one SoC, raw data associated with a raw image from at least one camera; generating, using the at least one SoC, an updated image based on the raw image from the at least one camera, wherein the updated image represents photons received by the at least one camera; providing, using the at least one SoC, the updated image to an image and signal processing pipeline; processing, using the at least one SoC, the updated image using the image and signal processing pipeline; and transmitting instructions for causing the vehicle to operate based at least in part on information obtained from an analysis of the processed image.

According to some non-limiting embodiments or examples, provided is an integrated circuit, comprising: a first hardware component configured for obtaining, from the at least one camera, an image, and providing the image to an image and signal processing pipeline; a second hardware component comprising the an image and signal processing pipeline, wherein the second hardware component is configured for identifying steps of the image and signal processing pipeline to be omitted in processing of the image, and for processing the image omitting the steps identified for omission; and a third hardware component configured for providing a processed image to a system of a vehicle for operating the vehicle based at least in part on information obtained from an analysis of the processed image.

Further non-limiting aspects or embodiments are set forth in the following numbered clauses:

Clause 1: A vehicle, comprising: at least one computer-readable medium storing computer-executable instructions; at least one processor communicatively coupled to at least one camera and configured to execute the computer executable instructions, the execution carrying out operations including: obtaining, using at least one SoC, raw data associated with a raw image from at least one camera; generating, using the at least one SoC, an updated image based on the raw image from the at least one camera, wherein the updated image represents photons received by the at least one camera; providing, using the at least one SoC, the updated image to an image and signal processing pipeline; processing, using the at least one SoC, the updated image using the image and signal processing pipeline; and transmitting instructions for causing the vehicle to operate based at least in part on information obtained from an analysis of the processed image.

Clause 2: The vehicle of clause 1, the operations comprising: identifying steps of the image and signal processing pipeline to be omitted in processing of the updated image.

Clause 3: The vehicle of any of the preceding clauses, wherein the processing of the updated image omits the steps identified for omission.

Clause 4: The vehicle of any of the preceding clauses, wherein identifying steps of the image and signal processing pipeline to be omitted in processing of the updated image comprises one or more hardware components to be omitted.

Clause 5: The vehicle of any of the preceding clauses, wherein identifying steps of the image and signal processing pipeline to be omitted in processing of the updated image are determined based on a state of the vehicle.

Clause 6: The vehicle of any of the preceding clauses, wherein the image and signal processing pipeline comprises one or more hardware components.

Clause 7: The vehicle of any of the preceding clauses, wherein the image and signal processing pipeline comprises one or more SoCs.

Clause 8: The vehicle of any of the preceding clauses, wherein the at least one camera comprises at least one electron camera.

Clause 9: The vehicle of any of the preceding clauses, wherein the raw image data is obtained by controlling an acquisition time of the at least one camera.

Clause 10: The vehicle of any of the preceding clauses, wherein the raw image data comprises an approximation of an amount of photons.

Clause 11: A method comprising carrying out the operations specified in any of the preceding clauses.

Clause 12: A non-transitory computer-readable storage medium comprising at least one program for execution by one or more processors of a first device, the at least one program including instructions which, when executed by the one or more processors, cause the first device to perform the method of the preceding clause.

Clause 13: An integrated circuit, comprising: a first hardware component configured for obtaining, from the at least one camera, an image, and providing the image to an image and signal processing pipeline; a second hardware component comprising the an image and signal processing pipeline, wherein the second hardware component is configured for identifying steps of the image and signal processing pipeline to be omitted in processing of the image, and for processing the image omitting the steps identified for omission; and a third hardware component configured for providing a processed image to a system of a vehicle for operating the vehicle based at least in part on information obtained from an analysis of the processed image.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A vehicle, comprising:
at least one computer-readable medium storing computer-executable instructions;
at least one processor communicatively coupled to at least one camera and configured to execute the computer executable instructions, the execution carrying out operations including:
obtaining, using at least one SoC, raw data associated with a raw image from at least one camera;
generating, using the at least one SoC, an updated image based on the raw image from the at least one camera, wherein the updated image represents photons received by the at least one camera;
providing, using the at least one SoC, the updated image to an image and signal processing pipeline;
processing, using the at least one SoC, the updated image using the image and signal processing pipeline; and
transmitting instructions for causing the vehicle to operate based at least in part on information obtained from an analysis of the processed image.

2. The vehicle of claim 1, the operations comprising:
identifying steps of the image and signal processing pipeline to be omitted in processing of the updated image.

3. The vehicle of claim 2, wherein the processing of the updated image omits the steps identified for omission.

4. The vehicle of claim 2, wherein identifying steps of the image and signal processing pipeline to be omitted in processing of the updated image comprises one or more hardware components to be omitted.

5. The vehicle of claim 2, wherein identifying steps of the image and signal processing pipeline to be omitted in processing of the updated image are determined based on a state of the vehicle.

6. The vehicle of claim 1, wherein the image and signal processing pipeline comprises one or more hardware components.

7. The vehicle of claim 1, wherein the image and signal processing pipeline comprises one or more SoCs.

8. The vehicle of claim 1, wherein the at least one camera comprises at least one electron camera.

9. The vehicle of claim 1, wherein the raw image data is obtained by controlling an acquisition time of the at least one camera.

10. The vehicle of claim 1, wherein the raw image data comprises an approximation of an amount of photons.

11. A method comprising:
obtaining, using at least one SoC, raw data associated with a raw image from at least one camera;
generating, using the at least one SoC, an updated image based on the raw image from the at least one camera, wherein the updated image represents photons received by the at least one camera;
providing, using the at least one SoC, the updated image to an image and signal processing pipeline;
processing, using the at least one SoC, the updated image using the image and signal processing pipeline; and
transmitting instructions for causing the vehicle to operate based at least in part on information obtained from an analysis of the processed image.

12. The method of claim 11, comprising:
identifying steps of the image and signal processing pipeline to be omitted in processing of the updated image.

13. The vehicle of claim 2, wherein processing of the updated image omits the steps identified for omission.

14. The vehicle of claim 2, wherein identifying steps of the image and signal processing pipeline to be omitted in processing of the updated image comprises one or more hardware components to be omitted.

15. The vehicle of claim 2, wherein identifying steps of the image and signal processing pipeline to be omitted in processing of the updated image are determined based on a state of the vehicle.

16. The method of claim 11, wherein the image and signal processing pipeline comprises one or more hardware components.

17. The method of claim 11, wherein the image and signal processing pipeline comprises one or more SoCs.

18. The method of claim 11, wherein the at least one camera comprises at least one electron camera.

19. The method of claim 11, wherein the raw image data is obtained by controlling an acquisition time of the at least one camera and comprises an approximation of an amount of photons.

20. A non-transitory computer-readable storage medium comprising at least one program for execution by one or more processors of a first device, the at least one program including instructions which, when executed by the one or more processors, cause the first device to perform operations comprising:
obtaining, using at least one SoC, raw data associated with a raw image from at least one camera;
generating, using the at least one SoC, an updated image based on the raw image from the at least one camera, wherein the updated image represents photons received by the at least one camera;
providing, using the at least one SoC, the updated image to an image and signal processing pipeline;
processing, using the at least one SoC, the updated image using the image and signal processing pipeline; and
transmitting instructions for causing the vehicle to operate based at least in part on information obtained from an analysis of the processed image.
